(19) United States
(12) Patent Application Publication
(10) Pub. No.: US 2005/0200048 A1
(43) Pub. Date: Sep. 15, 2005

(54) Apparatus for valve-gate injection molding and method for the same

(76) Inventors: Shuji Fujii, Kyoto (JP); Hitoshi Takeuchi, Kyoto (JP); Nobuo Takahashi, Yonezawa (JP)

Correspondence Address: SHINJYU GLOBAL IP COUNSELORS, LLP, 1233 20TH STREET, NW, SUITE 700, WASHINGTON, DC, 20036-2680, US

(21) Appl. No.: 10/906,842

(22) Filed: Mar. 9, 2005

(30) Foreign Application Priority Data
Mar. 9, 2004 (JP) 2004-065316

(51) Int. Cl. B29C 45/23; B29C 45/73

(52) U.S. Cl. 264/328.16; 425/564

(57) ABSTRACT

An apparatus for valve-gate injection molding producing an annular molded product having a center through-hole has a valve gate with a simplified structure. The apparatus includes a movable mold member having a first center bore extending in an axial direction, a stationary mold member having a second center bore corresponding to the first bore and providing a product cavity forming the annular molded product between the mold members, a nozzle mounted on the stationary mold member and having a resin supply route having an opening communicating with the second bore, a valve pin extending in the resin supply route and movable between a closing position for closing the opening and an opening position for opening the opening, a center pin movably arranged in the first bore and having a tip surface in contact with a tip surface of the valve pin, and a driving mechanism driving the center pin in the axial direction.

### BACKGROUND OF THE INVENTION

1. Field of the Invention

The present invention relates to an apparatus for injection molding and method for the same, particularly, to an apparatus for valve-gate injection molding to produce an annular resin molded product and method for the same.

2. Background Information

An apparatus for injection molding includes a mold unit for molding a product. The mold unit includes a stationary mold and a movable mold, and a product cavity is provided therebetween. The movable mold is opened and closed by a clamping unit. In addition, the apparatus for injection molding includes a nozzle for supplying thermoplastics resin in a molten state to the mold unit. The nozzle has a resin supply route through which the thermoplastics resin is supplied. An opening of the resin supply route connects with a center bore of the stationary mold. Here, a valve gate has a mechanism for opening an opening of the nozzle, i.e., a gate hole, to inject the resin into the product cavity of the mold unit, and closing the gate hole to seal the product cavity. The valve gate is mainly composed of a valve pin, which is movable in its axial direction within the resin supply route, to open and close the gate hole.

A valve gate that is used to mold an annular product (product having a through-hole in its center) is composed of a tubular valve pin and a center pin. The center pin is inserted in the tubular valve pin. With this structure, an annular gate hole is formed around the center pin. The annular gate hole is opened and closed by the valve pin. Further, a fixed pin is arranged in the movable mold. The center pin and the fixed pin are in contact with each other while the stationary mold and the movable mold are being clamped. As a result of this, a resin molded product has a central through-hole defined by an outer circumference of the fixed pin.

In the apparatus for valve-gate injection molding using a sleeve gate described above, the tubular valve pin and the center pin inserted in the tubular valve pin need to be arranged within the nozzle. Thus, the valve gate has a complicated structure.

In view of the above, it will be apparent to those skilled in the art from this disclosure that there exists a need for an apparatus for valve-gate injection molding for producing an annular molded product and a method for the same. This invention addresses this need in the art as well as other needs, which will become apparent to those skilled in the art from this disclosure.

### SUMMARY OF THE INVENTION

An object of the present invention is to simplify the structure of a valve gate used in an apparatus for valve-gate injection molding for producing an annular molded product and a method for the same.

The above object is achieved by an apparatus for valve-gate injection molding of the present invention for injection molding an annular resin molded product having a through-hole. The apparatus includes a first mold member, a second mold member, a nozzle, a valve pin, a center pin, and a driving mechanism. A first center bore extending in an axial direction is formed in the first mold member. The second mold member provides a space for forming the resin molded product between the first mold member and the second mold member. A second center bore corresponding to the first center bore is formed in the second mold member. The nozzle is mounted on the second mold member, and has a resin supply route having an opening that connects with the second center bore. The valve pin extends in the resin supply route, and is movable between a closing position, at which the valve pin closes the opening, and an opening position, at which the valve pin retreats within the resin supply route from the closing position and opens the opening. The center pin is movably arranged in the first center bore, and has a tip surface coming in contact with a tip surface of the valve pin. The driving mechanism drives the center pin in the axial direction.

In the apparatus described above, the valve pin is first positioned to close the opening of the resin supply route. In that state, the molten resin does not flow from the resin supply route into the space between the first mold member and the second mold member. When the driving mechanism drives the center pin toward the second mold member, the center pin presses the valve pin, so that the valve pin moves from the closing position to the opening position, to open the opening of the resin supply route. This causes the molten resin to flow from the resin supply route into the space between the first mold member and the second mold member. When the molten resin is sufficiently filled in the space, the center pin returns to the original position, so that the valve pin returns to the closing position, to close the opening of the resin supply route. This causes the resin to stop flowing from the resin supply route into the space. As a result of this, an annular molded product having a through-hole, which is defined by an outer circumference of the center pin, is obtained in the space.

In the apparatus described above, the center pin presses the valve pin, to open the opening of the resin supply route. Thus, the valve pin is a solid-core member that can close the opening. In the apparatus for injection molding for injection molding the annular molded product, the valve gate has a simplified structure compared with conventional valve gates.

In the apparatus for valve-gate injection molding, the tip of the valve pin has a larger diameter than the tip of the center pin. With such a larger diameter, the rim of the tip surface of the valve pin is exposed in the space when the valve pin is at the closing position.

In the apparatus described above, when the valve pin returns to the closing position after the resin is filled in the space, the rim of the tip surface of the valve pin forms an axial direction end surface of the annular molded product around the through-hole. Thus, the axial direction end surface of the annular molded product is less likely to have marks of the gate.

The valve-gate injection molding apparatus further includes a pressing mechanism for pressing the valve pin against the center pin.

In this apparatus, when the center pin returns to the original position, the valve pin is pressed by the pressing mechanism, to move together with the center pin. In this way, the tip surfaces of the valve pin and the center pin are kept in contact. Thus, the resin is less likely to flow into a space between the tip surfaces of the valve pin and the center pin. The annular resin molded product is less likely to have burrs.

The above object is also achieved by a method for valve-gate injection molding of the present invention using an apparatus for valve-gate injection molding for injection molding an annular resin molded product having a through-hole. The apparatus includes a first mold member, a second mold member, a nozzle, a valve pin, a center pin, and a driving mechanism. A first center bore extending in an axial direction is formed in the first mold member. The second mold member provides a space for forming the resin molded product between the first mold member and the second mold member. A second center bore corresponding to the first center bore is formed in the second mold member. The nozzle is mounted on the second mold member, and has a resin supply route having an opening that connects with the second center bore. The valve pin extends in the resin supply passage. The valve pin is movable between a closing position, at which the valve pin closes the opening, and an opening position, at which the valve pin retreats within the resin supply route from the closing position and opens the opening. The center pin is movably arranged in the first center bore, and has a tip surface coming in contact with a tip surface of the valve pin. The driving mechanism drives the center pin in the axial direction.

The method for valve-gate injection molding includes
a clamping process of engaging the first mold member and the second mold member with each other to provide the space between the first mold member and the second mold member,
an injection process of driving the center pin toward the valve pin using the driving mechanism to cause the valve pin to be pressed and thereby move from the closing position to the opening position, so that resin flows from the resin supply route of the nozzle into the space via the opening,
a valve gate closing process of stopping the driving mechanism driving the center pin, to cause the valve pin to move from the opening position to the closing position, so that the resin stops flowing into the space,
a cooling process of cooling the resin within the space for a predetermined time after the valve gate closing process, and
a mold opening process of disengaging the first mold member and the second mold member from each other, and removing the resin molded product.

In this apparatus, the valve pin is first positioned to close the opening of the resin supply route. In that state, the molten resin does not flow from the resin supply route into the space between the first mold member and the second mold member. When the driving mechanism drives the center pin toward the second mold member, the center pin presses the valve pin, so that the valve pin moves from the closing position to the opening position, to open the opening of the resin supply route. This causes the molten resin to flow from the resin supply route into the space between the first mold member and the second mold member. When the molten resin is sufficiently filled in the space, the center pin returns to the original position, so that the valve pin returns to the closing position, to close the opening of the resin supply route. This causes the resin to stop flowing from the resin supply route into the space. As a result of this, an annular molded product having a through-hole, which is defined by an outer circumference of the center pin, is obtained in the space.

With this method, the center pin presses the valve pin, to open the opening of the resin supply route. Thus, the valve pin is a solid-core member that can close the opening. With the method for injection molding for injection molding the annular molded product, the valve gate has a simplified structure compared with conventional valve gates.

### BRIEF DESCRIPTION OF THE DRAWINGS

Referring now to the attached drawings which form a part of this original disclosure:

FIG. 1 shows an overall structure of an apparatus for injection molding according to a preferred embodiment of the present invention;

FIG. 2 is a partially enlarged view of the apparatus for injection molding of FIG. 1, for explaining a driving mechanism driving a center pin;

FIG. 3 is a partially enlarged cross sectional view of the apparatus for injection molding of FIG. 1, and shows a part around a product cavity formed by a stationary mold and a movable mold;

FIG. 4 is a cross sectional view of the same part as the part shown in FIG. 3, and shows a state in which a valve gate is opened to fill resin in the product cavity; and

FIG. 5 is a cross sectional view of the same part as the part shown in FIG. 3, and shows a state in which the valve gate is closed after resin is filled in the product cavity.

### DETAILED DESCRIPTION OF THE PREFERRED EMBODIMENT

Selected embodiments of the present invention will now be explained with reference to the drawings. It will be apparent to those skilled in the art from this disclosure that the following descriptions of the embodiments of the present invention are provided for illustration only and not for the purpose of limiting the invention as defined by the appended claims and their equivalents.

(1) Structure

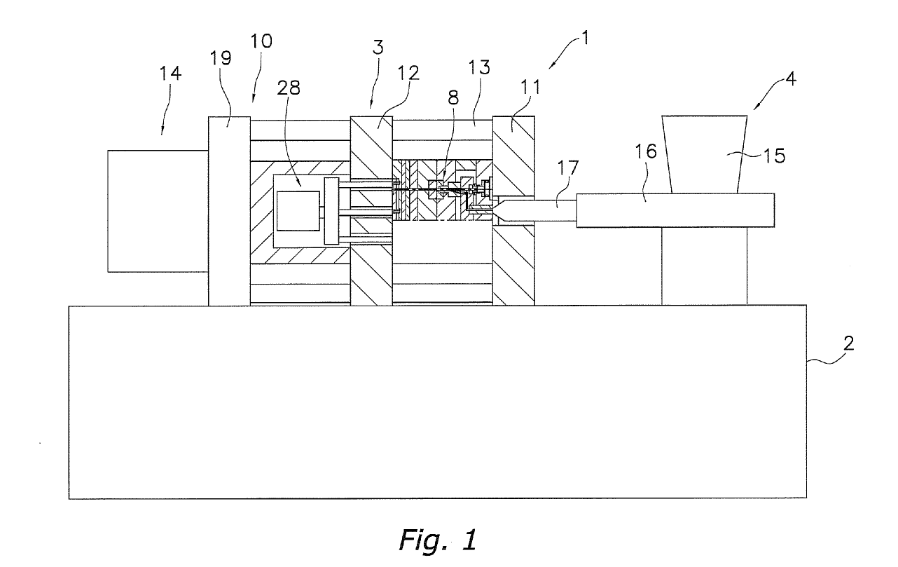

FIG. 1 shows a schematic structure of an apparatus for injection molding 1 according to a preferred embodiment of the present invention. The apparatus for injection molding 1 is arranged on a top surface of a base 2. The apparatus for injection molding 1 is mainly composed of a mold unit 3 and a resin supply unit 4. The resin supply unit 4 includes a hopper 15, a heating cylinder 16, and an injection nozzle 17. A resin material is placed in the hopper 15. The injection nozzle 17 is connected to the mold unit 3. A screw, which can reciprocate while rotating, is accommodated in the heating cylinder 16. The screw feeds the resin toward the injection nozzle 17 while melting the resin.

For ease of explanation with reference to the figure, the horizontal direction in the figure is hereafter referred to as the “axial direction”, the left side in the horizontal direction as the “axial first side” and the right side in the horizontal direction as the “axial second side”.

The mold unit 3 employs a valve-gate hot runner system. The mold unit 3 includes a mold 8 (described later) for molding an annular molded product 41. The annular molded product referred to herein intends to mean an annular member in which a through-hole is formed, and also includes a tubular member that extends long in the axial direction. In the preferred embodiment, the annular molded product 41 is specifically a turntable for rotationally driving discs, such as CDs and DVDs. However, the annular molded product 41 may also be a flange, a roller, a gear, etc.

A clamping unit 10 for opening and closing the mold unit 3 includes a stationary platen 11 and a movable platen 12. The movable platen 12 is on the left side of the stationary platen 11 in FIG. 1. The movable platen 12 is movable toward and away from the stationary platen 11 along tie bars 13, and is driven in the axial direction by a driving unit 14. The four tie bars 13 are respectively fixed to the four corners of a base platen 19 and to the four corners of the stationary platen 11. The movable platen 12 has four holes at its four corners, and the tie bars 13 pass through the holes of the movable platen 12. With the tie bars 13 passing through the holes of the movable platen 12, the movable platen 12 is supported in a manner movable toward and away from the stationary platen 11 in the axial direction. The driving unit 14 is formed, for example, by a servomotor or a toggle mechanism.

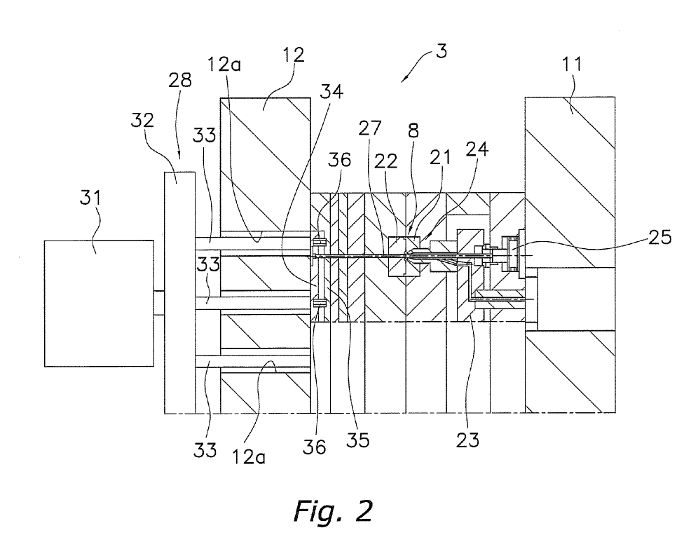

As shown in FIG. 2, the mold 8 is composed of a stationary mold 21 and a movable mold 22. The stationary mold 21 is mounted on the stationary platen 11. The movable mold 22 is mounted on the movable platen 12. The movable platen 12 described above is moved, to cause the movable mold 22 to be engaged with or disengaged from the stationary mold 21.

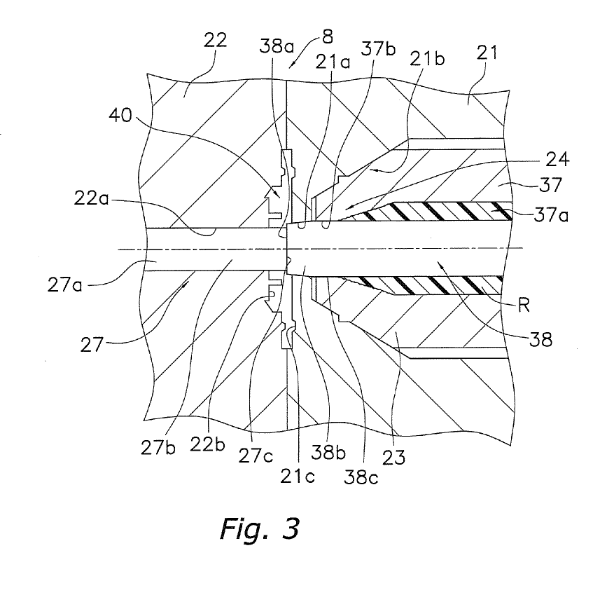

As shown in FIG. 3, the stationary mold 21 and the movable mold 22 of the mold 8 respectively have recessions 21c and 22b in their contact surfaces. The recessions 21c and 22b define a product cavity 40 in which resin is to be filled. The recession 21c defines to the shape of an upper part of the annular molded product 41. The recession 22b defines the shape of a lower part of the annular molded product 41. The movable mold 22 has a first center bore 22a, which extends in the axial direction to the center of the product cavity 40. The first center bore 22a is a circular bore that extends linearly with a constant diameter.

The stationary mold 21 has an insertion recession 21b, into which a tip part of a nozzle 37 (described later) is fittingly inserted. The insertion recession 21b has a tapered shape corresponding to the shape of the tip part of the nozzle 37. The stationary mold 21 has a second center bore 21a, which is a through-hole in the axial direction formed in the center of the insertion recession 21b. The second center bore 21a is formed to correspond to the first center bore 22a, and connects with the product cavity 40. The second center bore 21a is tapered toward the movable mold 22, and has a smaller diameter as being closer to the movable mold 22.

The tip part of the nozzle 37 is inserted in the insertion recession 21b of the stationary mold 21. A resin supply route 37a, which extends in the axial direction, is formed in the nozzle 37. Resin R in a molten state is supplied from the resin supply unit 4 described above into the resin supply route 37a via a manifold 23. An opening (gate hole) 37b of the resin supply route 37a is formed in the tip of the nozzle 37. The opening 37b is adjacent to the second center bore 21a of the stationary mold 21 and corresponds to the second center bore 21a. The opening 37b is circular, and extends linearly in the axial direction. A heater (not shown) is embedded in the nozzle 37 for maintaining the resin R in the resin supply route 37a in a molten state.

The following describes the valve gate 24. The valve gate 24 has the function of opening the opening 37b, i.e., the gate hole, to inject the resin R into the product cavity 40 of the mold 8, and closing the opening 37b to seal the product cavity 40. The valve gate 24 includes a valve pin 38 and a center pin 27.

The valve pin 38 is a member extending in the axial direction within the resin supply route 37a. The valve pin 38 is movable in the axial direction within the resin supply route 37a. An air cylinder 25 for pressing the valve pin 38 to the axial first side is arranged on the axial second side of the nozzle 37. An outer circumference of a tip part 38b of the valve pin 38 complementarily comes in contact with an inner circumference of the second center bore 21a of the stationary mold 21. This means that the tip part 38b of the valve pin 38 also has a tapered shape. This contact prevents the valve pin 38 from moving toward the movable mold 22 any further. An outer circumference of a closing part 38c of the valve pin 38 (a part closer to the stationary mold 21 than the tip part 38b) comes in contact with an inner circumference of the opening 37b of the nozzle 37. In this way, the closing part 38c closes the opening 37b. The closing part 38c extends linearly in the axial direction in the same manner as the opening 37b. The closing part 38c has the same diameter as a main part of the valve pin 38. The valve pin 38 is pressed toward the second center bore 21a of the stationary mold 21 by the air cylinder 25, so that the valve pin 38 is maintained in the state shown in FIG. 3.

The center pin 27 has the function of driving the valve pin 38 described above. Further, the center pin 27 has the function of defining a through-hole 41a, which is formed in the center of the annular molded product 41 when the annular molded product 41 is molded. The center pin 27 is a cylindrical narrow member arranged in the first center bore 22a, and is movable in the axial direction. The center pin 27 has a main part 27a and a tip part 27b. The main part 27a of the center pin 27 has the same diameter as the first center bore 22a. The tip part 27b of the center pin 27 extends from the first center bore 22a into the product cavity 40. In the state shown in FIG. 3, a tip surface 27c of the center pin 27 is in contact with a tip surface 38a of the valve pin 38 within the product cavity 40. The tip surface 38a has a larger diameter than the tip surface 27c. With such a larger diameter, the rim, i.e. the radially outward portion, of the tip surface 38a is exposed to the movable mold 22 within the product cavity 40.

Further, a center pin driving mechanism 28 is arranged on the axial first side of the center pin 27. The driving mechanism 28 includes a motor 31, an ejector plate 32, a plurality of ejector rods 33, and a driving plate 34. The motor 31 is arranged on the axial first side of the movable platen 12. The ejector plate 32 is arranged between the motor 31 and the movable platen 12, and is driven by the motor 31. The ejector rods 33 are driven by the ejector plate 32, and are movable in the axial direction within holes 12a formed in the movable platen 12. The tips of the ejector rods 33 come in contact with the driving plate 34 in a manner that the tips can be moved away from the driving plate 34. The motor 31 is a mechanism that can be switched between the state for applying a load to the ejector plate 32 to the axial second side and the state not applying such a load. A side surface of an end of the center pin 27 is fixed to the driving plate 34. The driving plate 34 is arranged in a recession formed in the axial first side surface of a contact plate 35. The driving plate 34 is movable in the axial direction. The driving plate 34 provides a space formed in the axial direction between the driving plate 34 and the contact plate 35. In the state shown in FIG. 2, the driving plate 34 comes in contact with the axial second side surface of the movable platen 12. Thus, when the driving plate 34 comes in contact with the contact plate 35, the center pin 27 stops moving. A plurality of coil springs 36 are arranged in a space formed in the axial direction between the driving plate 34 and the contact plate 35. When the driving plate 34 is at a position away at least from the movable platen 12 to the axial second side, the coil springs 36 as return springs are applying an elastic force to the driving plate 34 to the axial first side.

(2) Operations

1) Clamping Process

First, the driving unit 14 of the clamping unit 10 moves the movable platen 12 to the axial second side along the tie bars 13. This causes the movable mold 22 of the mold 8 to be engaged with the stationary mold 21 of the mold 8, so that the product cavity 40 is provided between the movable mold 22 and the stationary mold 21. In this state, the valve pin 38, which is pressed by an air pressure applied by the air cylinder 25, is at the position shown in FIG. 3.

2) Opening Operation of the Valve Gate

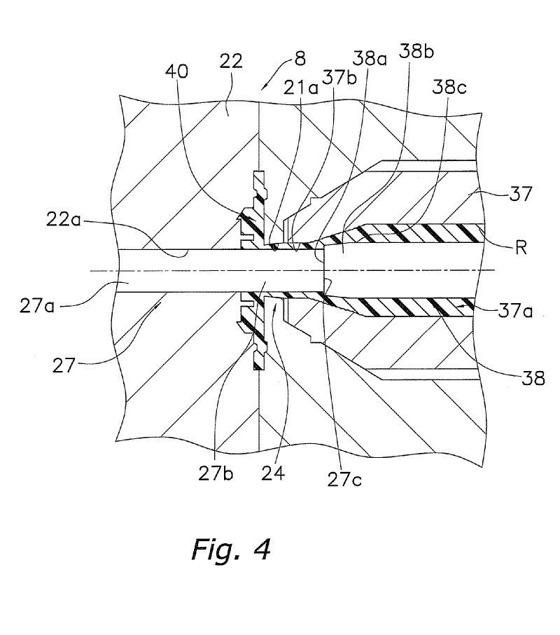

The motor 31 is driven in the state shown in FIG. 3, so that the motor 31 drives the ejector plate 32 to the axial second side. This causes the ejector rods 33 to press the driving plate 34 in the axial direction, so that the center pin 27 moves to the axial second side. The center pin 27 moves toward the stationary mold 21 while pressing the valve pin 38 that has been in the state shown in FIG. 3. The tip surface 27c of the center pin 27 enters the second center bore 21a, passes through the second center bore 21a, and further passes through the opening 37b, to move into the resin supply route 37a. With the operation described above, the valve pin 38 moves to the axial second side, and the tip part 38b is moved out of the second center bore 21a. As shown in FIG. 4, the tip part 27b of the center pin 27 is positioned in the second center bore 21a and the opening 37b. In this state, a small gap is provided between an outer circumference of the tip part 27b of the center pin 27, and an inner circumference of the second center bore 21a and the opening 37b. The gap enables the second center bore 21a and the opening 37b to open in the axial direction.

3) Injection Process

Via the second center bore 21a and the opening 37b opening in the axial direction, the molten resin R flows from the resin supply route 37a into the product cavity 40. While flowing, the molten resin R is being heated by the heater embedded in the nozzle 37 and so its molten state is maintained stably. The opening time of the valve gate 24 (the advancing time of the center pin 27) is set using a timer.

4) Closing Operation of the Valve Gate

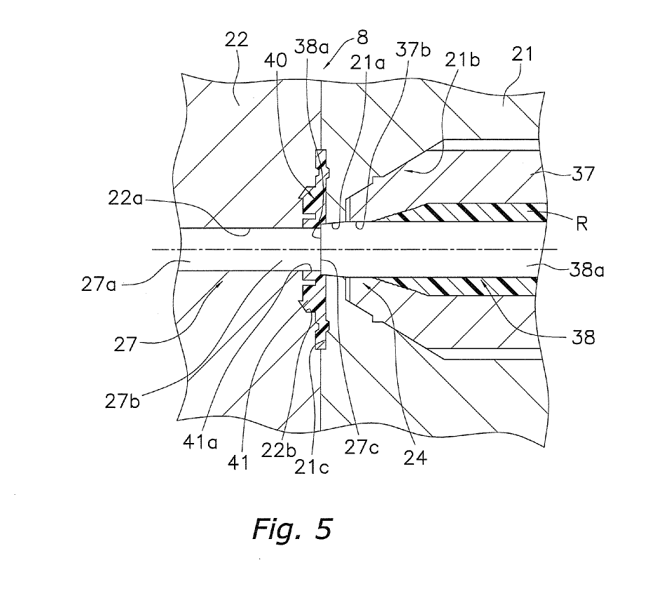

The motor 31 is driven when the advancing time of the center pin 27 has elapsed. This causes the ejector plate 32 and the ejector rods 33 to move to the axial first side. As a result, the load applied from the coil springs 36 causes the driving plate 34 to move to the axial first side as well. Thus, the center pin 27 also moves to the axial first side. In other words, shifting occurs from the state shown in FIG. 4 to the state shown in FIG. 5, so that the center pin 27 returns to the same position as the position shown in FIG. 3. During this operation, the valve pin 38 also moves while being in contact with the center pin 27 by a pressure applied from the air cylinder 25. In other words, the valve pin 38 and the center pin 27 move together, with their tip surfaces 27c and 38a being kept in contact. At the shifting from the state shown in FIG. 4 to the state shown in FIG. 5, the tip part 38b of the valve pin 38 presses the resin R in the vicinity of the second center bore 21a and the opening 37b into the product cavity 40. In the state shown in FIG. 5, the tip surface 38a of the valve pin 38 is positioned within the product cavity 40. The rim of the tip surface 38a of the valve pin 38 forms an axial direction end surface of the annular molded product 41 around the through-hole 41a in the movable mold 22.

5) Cooling Process

The annular molded product 41 is cooled for a predetermined time after the filling of the resin into the product cavity 40 described above is completed. As a result, the annular molded product 41 solidifies.

6) Mold Opening Process

Finally, the driving unit 14 of the clamping unit 10 moves the movable platen 12 to the axial first side along the tie bars 13. This causes the movable mold 22 of the mold 8 to be disengaged from the stationary mold 21 of the mold 8. The annular molded product 41 is removed from the stationary mold 21 together with the movable mold 22.

(3) Effects

In the apparatus for injection molding 1, the center pin 27 presses the valve pin 38 when the driving mechanism 28 drives the center pin 27 toward the stationary mold 21. The valve pin 38 moves from the closing position to the opening position, to open the opening 37b of the resin supply route 37a. This causes the resin R within the resin supply route 37a to flow into the product cavity 40. When the center pin 27 returns to the original position in that state, the valve pin 38 also returns to the closing position, to close the opening 37b of the resin supply route 37a. This causes the resin R to stop flowing from the resin supply route 37a into the product cavity 40. As a result of this, the annular molded product 41 having the through-hole 41a, which is defined by an outer circumference of the center pin 27, is obtained in the product cavity 40.

In this apparatus, the center pin 27 presses the valve pin 38, to open the opening 37b of the resin supply route 37a. Thus, the valve pin 38 is a solid-core member that can close the opening 37b. In the apparatus for injection molding 1 for injection molding the annular molded product 41 having the through-hole 41a, the valve gate 24 has a simplified structure compared with conventional valve gates.

The tip of the valve pin 38 has a larger diameter than the tip of the center pin 27. With such a larger diameter, the rim of the tip surface 38a of the valve pin 38 is exposed in the product cavity 40 when the valve pin 38 is at the closing position. When the valve pin 38 returns to the closing position after the resin is filled in the product cavity 40, the rim of the tip surface 38a of the valve pin 38 forms an axial direction end surface of the annular molded product 41 around the through-hole 41a. Thus, the axial direction end surface of the annular molded product 41 is less likely to have marks of the gate.

Further, the apparatus includes the air cylinder 25, which presses the valve pin 38 against the center pin 27. When the center pin 27 returns to the original position, the valve pin 38 is pressed by the air cylinder 25, to move together with the center pin 27. In this way, the tip surfaces 38a and 27c of the valve pin 38 and the center pin 27 are kept in contact. Thus, the resin is less likely to flow into a space between the tip surfaces 38a and 27c. The annular molded product 41 is less likely to have burrs.

As used herein, the following directional terms “forward, rearward, above, downward, vertical, horizontal, below, and transverse” as well as any other similar directional terms refer to those directions of a device equipped with the present invention. Accordingly, these terms, as utilized to describe the present invention should be interpreted relative to a device equipped with the present invention.

The term “configured” as used herein to describe a component, section or part of a device includes hardware and/or software that is constructed and/or programmed to carry out the desired function.

Moreover, terms that are expressed as “means-plus function” in the claims should include any structure that can be utilized to carry out the function of that part of the present invention.

The terms of degree such as “substantially,” “about,” and “approximately” as used herein mean a reasonable amount of deviation of the modified term such that the end result is not significantly changed. For example, these terms can be construed as including a deviation of at least +5% of the modified term if this deviation would not negate the meaning of the word it modifies.

This application claims priority to Japanese Patent Application No. 2004-065316. The entire disclosure of Japanese Patent Application No. 2004-065316 is hereby incorporated by reference.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents. Thus, the scope of the invention is not limited to the disclosed embodiments.

1. An apparatus for valve-gate injection molding for injection molding an annular resin molded product having a through-hole, comprising:
a first mold member in which a first center bore extending in an axial direction is formed;
a second mold member in which a second center bore corresponding to the first center bore is formed, the second mold member providing a space for forming the resin molded product between the first mold member and the second mold member;
a nozzle that is mounted on the second mold member, and has a resin supply route having an opening that connects with the second center bore;
a valve pin that extends in the resin supply route, and is movable between a closing position, at which the valve pin closes the opening, and an opening position, at which the valve pin retreats within the resin supply route from the closing position and opens the opening;
a center pin that is movably arranged in the first center bore, and has a tip surface coming in contact with a tip surface of the valve pin; and
a driving mechanism for driving the center pin in the axial direction.

2. The apparatus for valve-gate injection molding according to claim 1, wherein
a tip of the valve pin has a larger diameter than a tip of the center pin, and thereby a rim of the tip surface of the valve pin is exposed in the space when the valve pin is at the closing position.

3. The apparatus for valve-gate injection molding according to claims 1, further comprising
a pressing mechanism for pressing the valve pin against the center pin.

4. The apparatus for valve-gate injection molding according to claim 2, further comprising
a pressing mechanism for pressing the valve pin against the center pin.

5. A method for valve-gate injection molding using an apparatus for valve-gate injection molding for injection molding an annular resin molded product having a through-hole, wherein the apparatus includes:
a first mold member in which a first center bore extending in an axial direction is formed;
a second mold member in which a second center bore corresponding to the first center bore is formed, the second mold member providing a space for forming the resin molded product between the first mold member and the second mold member;
a nozzle that is mounted on the second mold member, and has a resin supply route having an opening that connects with the second center bore;
a valve pin that extends in the resin supply route, and is movable between a closing position, at which the valve pin closes the opening, and an opening position, at which the valve pin retreats within the resin supply route from the closing position and opens the opening;
a center pin that is movably arranged in the first center bore, and has a tip surface coming in contact with a tip surface of the valve pin; and
a driving mechanism for driving the center pin in the axial direction, the method comprising:
a clamping step of engaging the first mold member and the second mold member with each other to provide the space between the first mold member and the second mold member;
an injection step of driving the center pin toward the valve pin using the driving mechanism to cause the valve pin to be pressed and thereby move from the closing position to the opening position, so that resin flows from the resin supply route of the nozzle into the space via the opening;
a valve gate closing step of stopping the driving mechanism driving the center pin, to cause the valve pin to move from the opening position to the closing position, so that the resin stops flowing into the space;
a cooling step of cooling the resin within the space for a predetermined time after the valve gate closing step; and
a mold opening step of disengaging the first mold member and the second mold member from each other, and removing the resin molded product.
